(19) United States
(12) Patent Application Publication
(10) Pub. No.: US 2010/0073539 A1
(43) Pub. Date: Mar. 25, 2010

(54) SOLID-STATE IMAGING DEVICE

(75) Inventor: Takayuki ENDO, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/561,772

(22) Filed: Sep. 17, 2009

(30) Foreign Application Priority Data
Sep. 25, 2008 (JP) 2008-246773

(51) Int. Cl. H04N 5/335

(52) U.S. Cl. 348/308; 348/E05.091

(57) ABSTRACT

The solid-state imaging device which includes unit pixels arranged in a matrix pattern, and adds signals from the unit pixels, includes: column signal lines which transmit the signals from the unit pixels in a column direction; and ADCs which perform analog-digital conversion on the signals transmitted through the column signal lines, adds the converted signals, and outputs the added signal. The ADCs determines whether or not each signal from the unit pixels is a defective signal exceeding a predetermined voltage rage: when determined as not a defective signal, holds, as a signal to be added, a signal obtained through the analog-digital conversion of the signal determined as not a defective signal; and when determined as a defective signal, holds, as a signal to be added, a signal that is not a signal obtained through the analog-digital conversion of the defective signal.

### BACKGROUND OF THE INVENTION

(1) Field of the Invention

The present invention relates to solid-state imaging devices and methods for driving the same. Particularly, the present invention relates to a solid-state imaging device which converts analog signals outputted from unit pixels through column signal lines to digital signals and reads out the digital signals, and to a method for driving the same.

(2) Description of the Related Art

In recent years, as solid-state imaging devices, Complementary Metal Oxide Semiconductor (CMOS) image sensors including column parallel analog-digital converters (hereinafter, referred to as ADCs) have been reported. In the CMOS image sensors, the ADCs are arranged for respective columns in matrix-patterned unit pixels. In order to perform high-speed imaging, the CMOS image sensor sometimes adopts a method for increasing a frame rate by adding pixel signals (signals generated in unit pixels by photoelectric conversion) (see Patent Reference 1, Japanese Unexamined Patent Application Publication No. 2005-278135, for example).

In the CMOS image sensor disclosed in Patent Reference 1, unit pixels, each including a photoelectric conversion element, are two-dimensionally arranged in a matrix pattern, and column signal lines are arranged for respective columns of the matrix pattern, so that the unit pixels are selectively controlled for respective rows sequentially. The CMOS image sensor has a configuration in which analog signals (pixel signals) are outputted from the unit pixels in a selectively controlled row through the column signal lines, and converted to digital values. The obtained digital values are added among a plurality of unit pixels and the added digital value is read out. With this configuration in which the analog signals outputted from the unit pixels are converted to the digital values, the digital values are added among the plurality of unit pixels, and the added digital value is read out, for example, by adding the digital values between two unit pixels, total pixel information is reduced to ½, but the frame rate can be doubled.

### SUMMARY OF THE INVENTION

However, in the conventional technique disclosed in Patent Reference 1, that is, a technique for adding pixel signals, there is a problem in that if there is a unit pixel signal which includes a defective signal, the defective signal is included in a signal that is after addition, which results in deterioration of the image quality of an imaging result.

The present invention has been conceived in view of the problem above, and it is an object of the present invention to provide a solid-state imaging device which is capable of adding pixel signals without causing deterioration of the image quality of the imaging result.

In order to achieve the above object, the solid-state imaging device according to the present invention which includes pixels arranged in a matrix pattern and adds signals from the pixels, is structured as follows. The solid-state imaging device includes: a column signal line which transmits the signals from the pixels in a column direction; and an analog-digital conversion circuit which performs analog-digital conversion on the signals transmitted through said column signal line, adds the converted signals, and outputs the added signal. The analog-digital conversion circuit determines whether or not each of the signals from the pixels is a defective signal having a voltage exceeding a predetermined voltage range: and when the signal is determined as not the defective signal, the analog-digital conversion circuit holds, as a signal to be added, a signal obtained through the analog-digital conversion of the signal determined as not the defective signal; and when the signal is determined as the defective signal, the analog-digital conversion circuit holds, as a signal to be added, a signal that is not a signal obtained through the analog-digital conversion of the defective signal.

With this configuration, the analog-digital conversion circuit converts analog signals outputted from unit pixels to digital values, and also performs defect detection on each signal, from the pixels, which is before addition of the digital values. Since whether the addition is performed or not is controlled based on the result of the defect detection and then the signals are added among a plurality of unit pixels, the signal which is after the addition does not include the defective signal. As a result, it is possible to add pixel signals without causing deterioration of the image quality of the imaging result.

Here, when the signal is determined as the defective signal, the analog-digital conversion circuit may hold, as the signal to be added, a signal identical to one of the signals that have been held as the signals to be added. Alternatively, when the signal is determined as the defective signal, the analog-digital conversion circuit may hold, as the signal to be added, a signal obtained by multiplying an added value of the signals that have been held as the signals to be added, by a correction coefficient.

With this configuration, the signal determined as a defective signal and not added, is replaced with a signal derived based on normal signals which are not defective signals. As a result, the deterioration of the image quality of the imaging result can be further prevented.

According to the present invention, in the solid-state imaging device in which analog signals (pixel signals) outputted from the unit pixels through the column signal lines are converted into digital values, the digital values are added, and the added digital value is read out, the defective signal is detected and the detected defective signal is not added as it is. Therefore, even if there is a pixel outputting a defective signal, the signal which is after addition does not include the defective signal. As a result, the deterioration of the image quality of the imaging result is prevented and a fine image can be obtained.

### FURTHER INFORMATION ABOUT TECHNICAL BACKGROUND TO THIS APPLICATION

The disclosure of Japanese Patent Application No. 2008-246773 filed on Sep. 25, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a MOS image sensor according to Embodiment 1 of the present invention;

FIG. 2 is a circuit diagram of one of unit pixels;

FIG. 3 is a timing chart for illustrating a driving method of the MOS image sensor according to Embodiment 1;

FIG. 4 is a diagram showing a difference between a case where a defective signal is detected before signals are added and a case where the defective signal is detected after signals are added;

FIG. 5 is a block diagram showing a configuration of a MOS image sensor according to Embodiment 2 of the present invention; and

FIG. 6 is a timing chart for illustrating a driving method of the MOS image sensor according to Embodiment 2.

### DESCRIPTION OF THE PREFERRED EMBODIMENTS

Hereinafter, embodiments of the solid-state imaging device according to the present invention will be described in detail with reference to the drawings.

### Embodiment 1

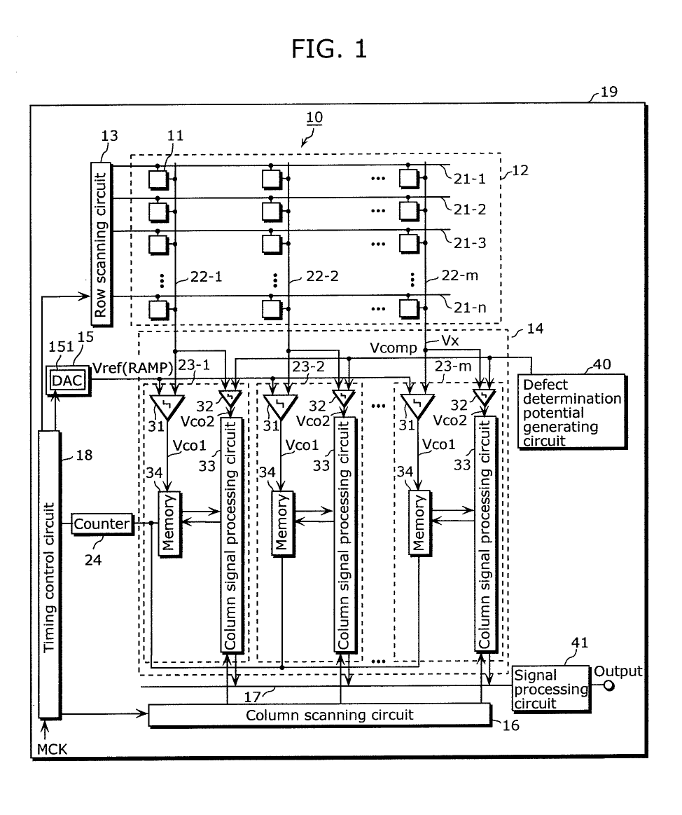

FIG. 1 is a block diagram showing a configuration of a solid-state imaging device according to Embodiment 1 of the present invention, for example, a MOS image sensor including column parallel ADCs.

A MOS image sensor 10 according to the present embodiment adds signals from unit pixels 11, and includes: a pixel array unit 12 in which the unit pixels 11, each including a photoelectric conversion element, are two-dimensionally arranged in a matrix pattern; a row scanning circuit 13; a column processing unit 14; a reference voltage supplying unit 15; a column scanning circuit 16; a horizontal output line 17; a counter 24; a defect determination potential generating circuit 40; a signal processing circuit 41, and a timing control circuit 18.

In the MOS image sensor 10, the timing control circuit 18 generates, based on a master clock MCK, clock signals and control signals serving as reference of the operations of the row scanning circuit 13, the column processing unit 14, the reference voltage supplying unit 15, the column scanning circuit 16 and the like. Then, the timing control circuit 18 supplies the generated signals to the column scanning circuit 13, the column processing unit 14, the reference voltage supplying unit 15, the column scanning circuit 16 and the like.

Peripheral systems such as a driving system and a signal processing system for driving and controlling each unit pixel 11 of the pixel array unit 12, that is, the row scanning circuit 13, the column processing unit 14, the reference voltage supplying unit 15, the column scanning circuit 16, the horizontal output line 17, the counter 24, the defect determination potential generating circuit 40, the signal processing circuit 41 and the timing control circuit 18 are integrated in a semiconductor chip (semiconductor substrate) 19 together with the pixel array unit 12.

In the pixel array unit 12, the unit pixels 11 of m columns and n rows are two-dimensionally arranged. With respect to the m columns and n rows of the unit pixels, row control lines 21-1 to 21-n are arranged for the respective rows, and column signal lines 22-1 to 22-m are arranged for the respective columns. One end of each of the row control lines 21-1 to 21-n is connected to a corresponding output terminal, provided so as to correspond to the respective rows of the unit pixels 11, of the row scanning circuit 13. The row control lines 21-1 to 21-n are for selectively controlling the rows of the unit pixels 11. The column signal lines 22-1 to 22-m are electrically connected to the respective unit pixels 11 to transmit signals from the unit pixels 11 in a column direction.

The row scanning circuit 13 is configured of a shift register or the like, and controls the row address and row scanning of the pixel array unit 12 through the row control lines 21-1 to 21-n.

The column processing unit 14 includes analog-digital conversion circuits (ADCs) 23-1 to 23-m, which are provided for the respective columns of the unit pixels 11 of the pixel array unit 12, that is, for the respective column signal lines 22-1 to 22-m. The ADCs 23-1 to 23-m convert analog signals outputted from the respective columns of the pixel units 11 of the pixel array unit 12 to digital signals and output the digital signals. The solid-state imaging device according to the present invention features the configuration of these ADCs 23-1 to 23-m, which will be described in detail later. Since the ADCs 23-1 to 23-m have the same configuration, the configuration of the ADC 23-m will be described as an example.

The ADC 23-m performs analog-digital conversion on pixel signals transmitted through the column signal line 22-m, adds the converted signals from the unit pixels 11 arranged in a column direction, and outputs the added signal.

The ADC 23-m determines, based on a defect determination potential Vcomp, whether or not each signal from the unit pixels 11 is a defective signal having a voltage exceeding a predetermined voltage range. When the signal is determined as not a defective signal, the ADC 23-m considers the signal as a normal signal, and holds, as a signal to be added, a signal obtained through the analog-digital conversion of the signal determined as not the defective signal. On the other hand, when determined as a defective signal, the ADC 23-m newly holds, as a signal to be added, a signal which is not the signal obtained through the analog-digital conversion of the defective signal.

More particularly, when determined as a defective signal, the ADC 23-m newly holds, as a signal to be added, a signal which is identical to one of the signals that have been held as signals to be added. When determined as a defective signal, the ADC 23-m may newly hold, as a signal to be added, a signal obtained by multiplying the added value of the signals that have been held as signals to be added, by correction coefficient. Further, when determined as a defective signal, the ADC 23-m may newly hold, as a signal to be added, a signal having an average value of the signals that have been held as signals to be added.

The reference voltage supplying unit 15 includes a digital-analog conversion circuit (DAC) serving as a unit for generating a reference voltage Vref having a so-called ramp waveform, in which the level changes in a ramp form with a lapse of time. Note that other units than the DAC 151 may be used as a unit for generating a reference voltage Vref having a ramp waveform.

The DAC 151 generates a reference voltage Vref having a ramp waveform based on a clock CK supplied from the timing control circuit 18 under the control by a control signal supplied from the timing control circuit 18, and supplies the reference voltage Vref to the ADCs 23-1 to 23-m of the column processing unit 14.

The defect determination potential generating circuit 40 generates a defect determination potential Vcomp which indicates a threshold for determining a defective signal. The defect determination potential Vcomp may be a fixed value or a value varying according to imaging conditions of the image sensor. The defect determination potential generating circuit 40 is provided on the semiconductor chip 19 in FIG. 1; however, it may be provided outside of the semiconductor chip 19.

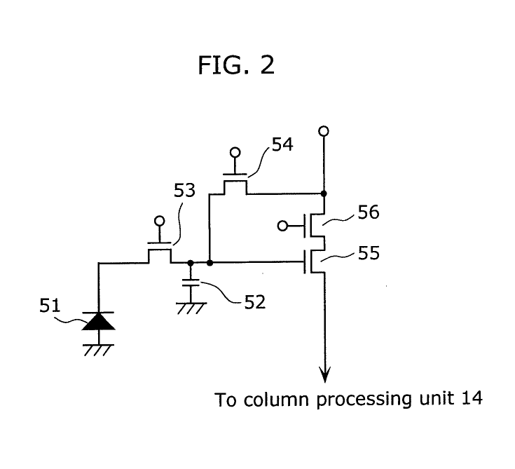

FIG. 2 is a circuit diagram of one of the unit pixels 11. Each of the unit pixels 11 is configured of four-transistors, and includes a photoelectric conversion element 51 (for example, photodiode), a transfer transistor 53 for transferring a signal charge obtained by photoelectric conversion in the photoelectric conversion element 51 to a floating diffusion (FD) unit 52, a reset transistor 54 for controlling the potential of the FD unit 52, an amplifier transistor 55 for outputting a signal voltage according to the potential of the FD unit 52, and a selecting transistor 56 for selecting the unit pixel 11. The unit pixel 11 may be configured of three-transistors excluding the selecting transistor 56.

Next, a specific configuration of the ADC 23-m featured by the solid-state imaging device according to the present invention is described.

The ADC 23-m includes a first comparator 31, a second comparator 32, a column signal processing circuit 33, and a memory device 34.

The device configuration of the ADC 23-m features the second comparator 32. The input of the second comparator 32 is connected to the defect determination potential Vcomp supplied from the defect determination potential generating circuit 40, and the column signal line 22-m. The second comparator 32 compares, with the defect determination potential Vcomp, each pixel signal, supplied from the column signal line 22-m, which is before converted from analog signal to digital signal and then transmits the comparison result to the column signal processing unit 33 using H/L signals.

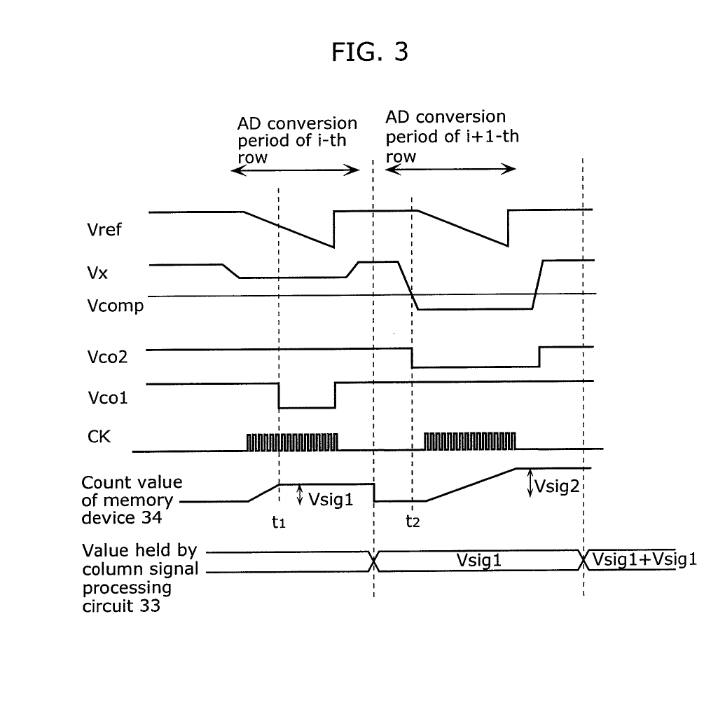

FIG. 3 is a timing chart for illustrating a driving method of the MOS image sensor 10 having the configuration of FIG. 1.

The first comparator 31 compares the signal voltage Vx of the column signal line 22-m according to the signals outputted from the unit pixels 11 in the m-th column of the pixel array unit 12 with the reference voltage Vref having a ramp waveform supplied from the reference voltage supplying unit 15. When the reference voltage Vref is higher than the signal voltage Vx, the output Vco1 of the first comparator 31 is in a “H” level. When the reference voltage Vref is equal to or lower than the signal voltage Vx, the output Vco1 of the first comparator 31 is in a “L” level (t1).

The second comparator 32 compares the signal voltage Vx of the column signal line 22-m according to the signals outputted from unit pixels 11 in the m-th column of the pixel array unit 12 with the defect determination potential Vcomp supplied from the defect determination potential generating circuit 40. When the signal voltage Vx is higher than the defect determination potential Vcomp, the output Vco2 of the second comparator 32 is in a “H” level. When the signal voltage Vx is equal to or lower than the defect determination potential Vcomp, the output Vco2 of the second comparator 32 is in a “L” level (t2).

The memory device 34 is an example of a measuring unit according to the present invention. The memory device 34 measures time period from when the comparison by the first comparator 31 starts to when the signal outputted from each unit pixel 11 reaches the reference voltage Vref. More particularly, the memory device 34 holds a value of the counter 24 at the same time as the output Vco1 of the first comparator 31 changes. The value of the counter 24 becomes a digital data corresponding to the signal voltage Vx, so that analog-digital conversion is implemented.

The column signal processing circuit 33 reads out the value of the memory device 34, holds the value, and performs an operation such as addition, subtraction, multiplication, division and average of the value and a value to be held by the memory device 34 in the analog-digital conversion of the next column scanning, so that addition or mixture of the signal voltages Vx among a plurality of unit pixels 11 is implemented.

The column signal processing circuit 33 determines whether or not to hold the measurement result obtained by the memory device 34, based on the comparison result obtained by the second comparator 32. In other words, when the signal voltage Vx of the unit pixel 11 in i+1-th row indicates that the signal voltage Vx is a defective signal, that is, the output Vco2 of the second comparator 32 is in a “L” level when the signal from the unit pixel 11 in i+1-th row is outputted, the column signal processing circuit 33 determines that the signal voltage Vx of the unit pixel 11 in i+1-th row as a defective signal. In this case, the digital data of the signal voltage Vx of the unit pixel 11 in i+1-th row is not used. Instead, the value derived from the signal voltage Vx of the unit pixel 11 in other row than the i+1-th row, which is to be added to the signal voltage Vx of the unit pixel 11 in i+1-th row and which is a normal signal but not a defective signal, becomes a digital data of the unit pixel 11 in i+1-th row. For example, the digital data of the unit pixel 11 which has been read out previously, such as the digital data of the unit pixel 11 in i-th row, becomes a digital data of the unit pixel 11 in i+1-th row.

Note that it may be that digital data of the unit pixels 11 in several rows, for example, digital data of the unit pixels 11 in all rows up to the i-th row, which have been read out previously, are added, and the added value is multiplied by correction coefficient k. The obtained value may be used as a digital data of the unit pixel 11 in i+1-th row. In this case, the correction coefficient k is a value for operating digital data per one pixel based on the added value of the digital data. Assuming that p is the number of the added unit pixels 11, the correction coefficient k can be represented as 1/p (where p is an integer number). Furthermore, assuming that the output Vco2 of the second comparator 32 indicating the signal voltage Vx is a defective signal, as being in a “H” level, the column signal processing circuit 33 may determine the signal voltage Vx as a defective signal when the signal voltage Vx is higher than the defect determination potential Vcomp.

The column scanning circuit 16 controls output of the digital signals added in the ADCs 23-1 to 23-m to the horizontal output line 17. The horizontal output line 17 transmits digital signals outputted from the ADCs 23-1 to 23-m.

The signal processing circuit 41 sequentially reads out outputs of the column signal processing circuits 33 by the column scanning circuit 16, adds the outputs among a plurality of data, and sequentially outputs the added data. The operation is sequentially repeated for each row so that a two-dimensional image is generated.

As described above, according to the MOS image sensor 10 in the present embodiment, the defect determination device including the second comparator 32 and the column signal processing circuit 33 detects a defective signal on each signal, from the unit pixels, which is before addition. When a defective signal is detected, the signal from the unit pixel 11, determined as a defective signal, is not used, but instead, the value derived from normal signals is used, which makes it possible to provide the following advantageous effects.

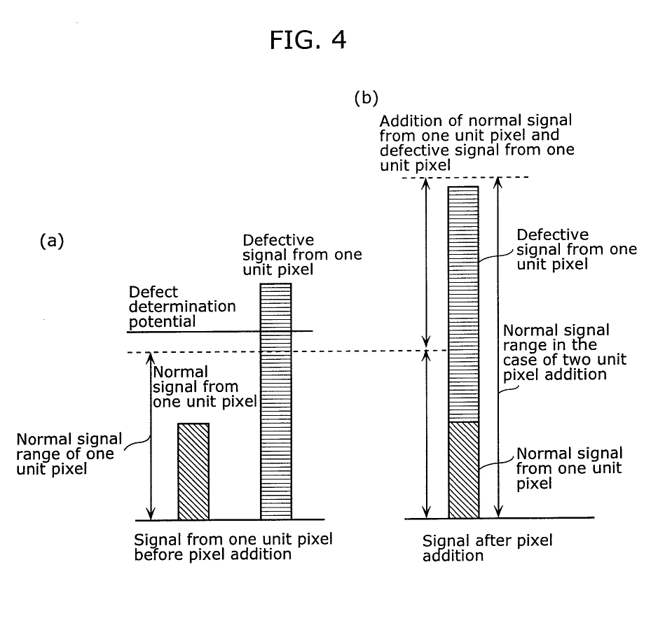

FIG. 4 is a diagram showing a signal, from one unit pixel, which is before addition and a signal which is after addition. Note that in the following description, the defect determination potential Vcomp is assumed as a potential higher than a normal signal range.

In the signal which is after addition, as shown in FIG. 4(b), even in the case where a defective signal and a normal signal are added, the added value is within the normal signal range of the case where normal signals from two unit pixels are added, which does not allow to detect a defective signal. On the other hand, as in the MOS image sensor 10 according to the present embodiment, when a signal from one unit pixel is compared to the defect determination potential, the defective signal from the one unit pixel exceeds the normal signal range of one unit pixel as shown in FIG. 4(a); and therefore the signal can be detected as a defective signal. When detected as a defective signal, the data of the defective signal is not used, but instead, the value obtained from the normal signals to be added is used, which makes it possible to eliminate influences of the defective signal from the one unit pixel.

In the present embodiment, it has been described that the ADC 23-m determines whether or not each signal from the unit pixels 11 is a defective signal by comparing the signal with the reference voltage.

However, the ADC 23-m may determine whether or not each signal from the unit pixels 11 is a defective signal by comparing, with a predetermined value, a signal obtained through the analog-digital conversion of a signal from the unit pixels 11. More particularly, the ADC 23-m may determine whether or not each signal from the unit pixels 11 is a defective signal by comparing the converted digital signal with a value equivalent to the defect determination potential Vcomp in the column signal processing circuit 33.

### Embodiment 2

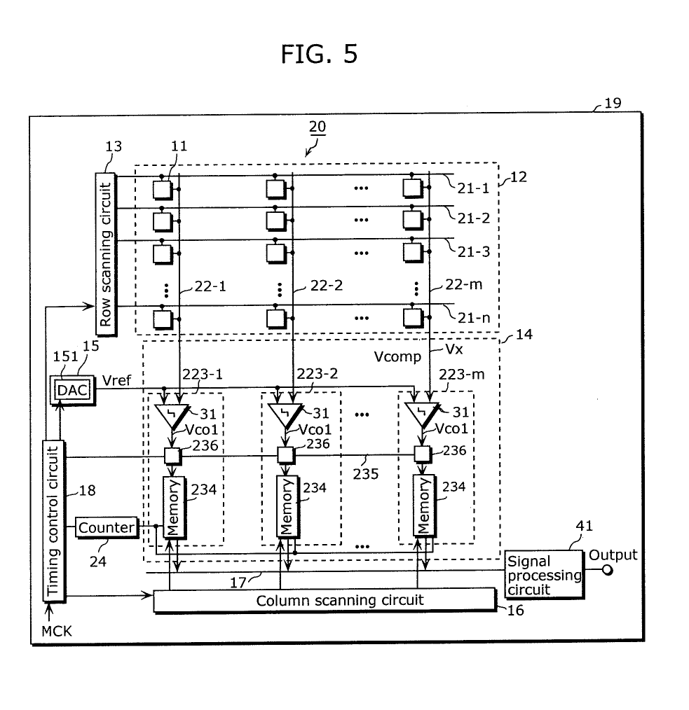

FIG. 5 is a block diagram showing a configuration of a solid-state imaging device according to Embodiment 2 of the present invention, for example, a MOS image sensor including a column parallel ADCs. Hereinafter, description is given focusing on the points different from the solid-state imaging device according to Embodiment 1.

In a MOS image sensor 20 according to the present embodiment, the ADCs 223-1 to 223-m have the same configuration. Hereinafter, the configuration of the ADC 223-m will be described as an example. The ADC 223-m includes a first comparator 31, a defect determination device 236 and a memory device 234.

The ADC 223-m performs analog-digital conversion on pixel signals transmitted through a column signal line 22-m, adds the converted signals from unit pixels 11 arranged in a column direction, and outputs the added signal.

The ADC 223-m determines whether or not each signal from the unit pixels 11 is a defective signal. When the signal is determined as not a defective signal, the ADC 223-m considers the signal as a normal signal, and holds, as a signal to be added, a signal obtained through the analog-digital conversion of the signal determined as not the defective signal. On the other hand, when determined as a defective signal, the ADC 223-m newly holds, as a signal to be added, a signal which is not the signal obtained through the analog-digital conversion of the defective signal.

More particularly, when determined as a defective signal, the ADC 223-m holds a zero-level signal as a signal to be added.

The output of the first comparator 31 is connected to the defect determination device 236, and the output of the defect determination device 236 is connected to the memory device 234. The defect determination device 236 latches the output Vco1 of the first comparator 31 on the rise time of the pulse of a defect determination timing instruction line 235, and outputs a logical sum of the output Vco1 and a defect determination device determining pulse which holds the state of the output Vco1 on the rise time of the pulse of the defect determination timing instruction line 235 while the defect determination timing instruction line 235 is in a “H” level.

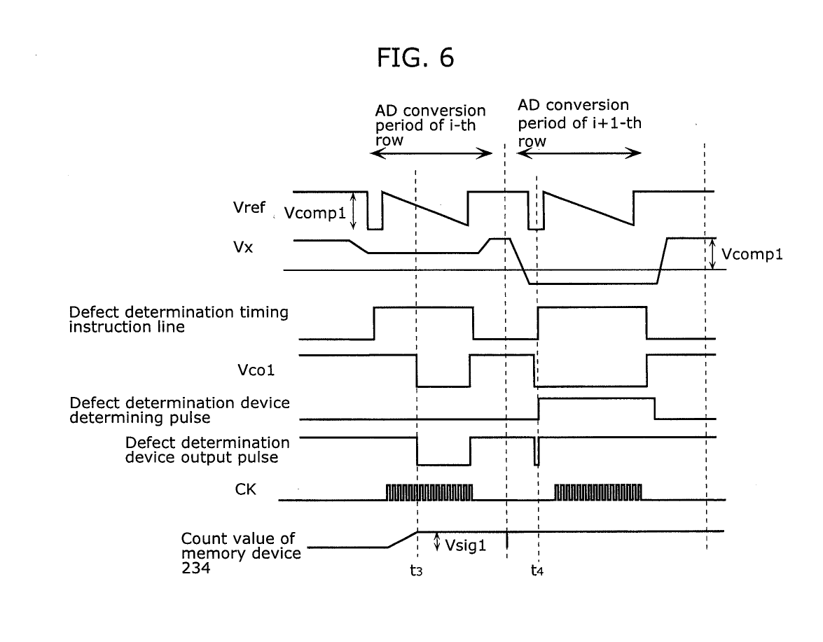

FIG. 6 is a timing chart for illustrating a driving method of the MOS image sensor 20 having the configuration of FIG. 5. The Vref outputted from a reference voltage supplying unit 15 has a period indicating the potential of the defect determination potential Vcomp1, a period indicating the potential of a ramp waveform, and a period indicating a reference signal.

The first comparator 31 compares the signal voltage Vx of the column signal line 22-m according to signals outputted from the unit pixels 11 in the m-th column of the pixel array unit 12 with the reference voltage Vref having a ramp waveform supplied from the reference voltage supplying unit 15. When the reference voltage Vref is higher than the signal voltage Vx, the output Vco1 of the first comparator 31 is in a “H” level. When the reference voltage Vref is equal to or lower than the signal voltage Vx, the output Vco1 of the first comparator 31 is in a “L” level (t3).

The potential of the defect determination timing instruction line 235 rises while the reference voltage Vref is at the potential of the defect determination potential Vcomp1, and falls when the reference voltage Vref is back to the standard signal after the potential period of the ramp waveform of the reference voltage Vref.

When the output Vco1 is in a “L” level at the rise time (t4) of the defect determination timing instruction line 235, the defect determination device determining pulse is in a “H” level while the defect determination timing instruction line 235 is in a “H” level.

The defect determination device output pulse (output from the defect determination device 236) is a logical sum of the output Vco1 and the defect determination device determining pulse. When both the output Vco1 and the defect determination device determining pulse are in a “L” level, the defect determination device output pulse is in a “L” level, and is in a “H” level in other cases.

The memory device 234 holds the value of the counter 24 at the same time as the level of the defect determination device output pulse changes. The value of the counter 24 becomes a digital data corresponding to the signal voltage Vx, so that analog-digital conversion is implemented.

The memory device 234 adds the value which have been held by the memory device 234 and the value to be held by the memory device 234 through the analog-digital conversion in the next row scanning, so that addition or mixture of the signal voltages Vx among a plurality of unit pixels 11 is implemented.

As described above, according to the MOS image sensor 20 in the present embodiment, when a signal falls below the potential of the defect determination potential Vcomp1 generated in the reference voltage supplying unit 15, and is determined as a defective signal, the signal from the unit pixel 11, determined as a defective signal, is not used, and it is assumed that a zero-level signal is outputted. Therefore, it is possible to obtain such a signal that only normal signals, not including the defective signal, are added.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to solid-state imaging devices, and especially to MOS image sensors including column parallel ADCs and the like.

What is claimed is:

1. A solid-state imaging device which includes pixels arranged in a matrix pattern and adds signals from the pixels, said solid-state imaging device comprising:
a column signal line which transmits the signals from the pixels in a column direction; and
an analog-digital conversion circuit which performs analog-digital conversion on the signals transmitted through said column signal line, adds the converted signals, and outputs the added signal,
wherein said analog-digital conversion circuit determines whether or not each of the signals from the pixels is a defective signal having a voltage exceeding a predetermined voltage range: and when the signal is determined as not the defective signal, said analog-digital conversion circuit holds, as a signal to be added, a signal obtained through the analog-digital conversion of the signal determined as not the defective signal; and when the signal is determined as the defective signal, said analog-digital conversion circuit holds, as a signal to be added, a signal that is not a signal obtained through the analog-digital conversion of the defective signal.

2. The solid-state imaging device according to claim 1,
wherein, when the signal is determined as the defective signal, said analog-digital conversion circuit holds, as the signal to be added, a signal identical to one of the signals that have been held as the signals to be added.

3. The solid-state imaging device according to claim 1,
wherein, when the signal is determined as the defective signal, said analog-digital conversion circuit holds, as the signal to be added, a signal obtained by multiplying an added value of the signals that have been held as the signals to be added, by a correction coefficient.

4. The solid-state imaging device according to claim 1,
wherein, when the signal is determined as the defective signal, said analog-digital conversion circuit holds, as the signal to be added, a signal having an average value of the signals that have been held as the signals to be added.

5. The solid-state imaging device according to claim 1,
wherein, when the signal is determined as the defective signal, said analog-digital conversion circuit holds a zero-level signal as the signal to be added.

6. The solid-state imaging device according to claim 5,
wherein said analog-digital conversion circuit compares each of the signals from the pixels with a reference voltage, so as to determine whether or not the signal is the defective signal.

7. The solid-state imaging device according to claim 6,
wherein said analog-digital conversion circuit includes:
a first comparator which compares each of the signals transmitted through said column signal line with the reference voltage;
a second comparator which compares each of the signals transmitted through said column signal line with a predetermined voltage;
a measurement unit configured to measure a time period from when the comparison by said first comparator starts to when the signal transmitted through said column signal line reaches the reference voltage; and
a signal processing unit configured to determine whether or not to hold a measurement result obtained by said measurement unit, based on a comparison result obtained by said second comparator.

8. The solid-state imaging device according to claim 5,
wherein said analog-digital conversion circuit compares, with a predetermined value, the signal obtained through the analog-digital conversion of each of the signals from the pixels, so as to determine whether or not the signal is the defective signal.

9. The solid-state imaging device according to claim 1,
wherein said analog-digital conversion circuit compares each of the signals from the pixels with a reference voltage, so as to determine whether or not the signal is the defective signal.

10. The solid-state imaging device according to claim 1,
wherein said analog-digital conversion circuit compares, with a predetermined value, the signal obtained through the analog-digital conversion of each of the signals from the pixels, so as to determine whether or not the signal is the defective signal.
